(19) United States
(12) Patent Application Publication
(10) Pub. No.: US 2015/0361322 A1
(43) Pub. Date: Dec. 17, 2015

(54) Method for Enhancing Fiber Bridging

(71) Applicants: Alexandrovna Olga MINIKH, Novosibirsk (RU); SCHLUMBERGER TECHNOLOGY CORPORATION, Sugar Land, TX (US)

(72) Inventors: Diankui Fu, Kuala Lumpur (MY); Olga Alexandrovna Minikh, Moscow (RU); Nicolas Droger, Paris (FR); Demid Valeryevich Demidov, Novosibirsk (RU)

(21) Appl. No.: 14/764,556

(22) PCT Filed: Jan. 29, 2013
(86) PCT No.: PCT/RU2013/000058

§ 371 Date: Jul. 29, 2015

(51) Int. Cl. C09K 8/36; E21B 33/138; E21B 43/26; E21B 21/00; E21B 43/04

(52) U.S. Cl. CPC C09K 8/36; E21B 21/003; E21B 43/04; E21B 43/26; E21B 33/138; C09K 2208/08

(57) ABSTRACT

Fluid compositions comprising rigid fibers, flexible fibers and solid plugging particles may effectively control the egress of fluids from a subterranean wellbore into vugs, cracks and fissures in the subterranean formation rock. The compositions may be effective in drilling fluids, cement slurries, gravel packing fluids, acidizing fluids and hydraulic fracturing fluids. Such fluids may also have utility for providing fluid diversion during well stimulation treatments, allowing the stimulation fluid to avoid higher permeability regions in the formation rock and treat the lower permeability regions, thereby improving stimulation results.

### BACKGROUND

The statements in this section merely provide background information related to the present disclosure and may not constitute prior art.

The present disclosure broadly relates to a method to enhance fiber bridging thereby controlling lost circulation during drilling of a wellbore.

During the drilling of a wellbore, various fluids are typically used in the well for a variety of functions. The fluids may be circulated through a drill pipe and drill bit into the wellbore, and then may subsequently flow upward through the wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

Fluid compositions used for these various purposes may be water- or oil-based and may comprise weighting agents, surfactants, proppants, or polymers. However, for a wellbore fluid to perform all of its functions and allow wellbore operations to continue, the fluid must stay in the borehole. Frequently, undesirable formation conditions are encountered in which substantial amounts or, in some cases, practically all of the wellbore fluid may be lost to the formation. For example, wellbore fluid can leave the borehole through large or small fissures or fractures in the formation or through a highly porous rock matrix surrounding the borehole.

Lost circulation is a recurring drilling problem, characterized by loss of drilling mud into downhole formations. It can occur naturally in formations that are fractured, highly permeable, porous, cavernous, or vugular. These earth formations can include shale, sands, gravel, shell beds, reef deposits, limestone, dolomite, and chalk, among others. Other problems encountered while drilling and producing oil and gas include stuck pipe, hole collapse, loss of well control, and loss of or decreased production.

Lost circulation may also result from induced pressure during drilling.

Specifically, induced mud losses may occur when the mud weight, required for well control and to maintain a stable wellbore, exceeds the fracture resistance of the formations. A particularly challenging situation arises in depleted reservoirs, in which the drop in pore pressure weakens hydrocarbon-bearing rocks, but neighboring or inter-bedded low permeability rocks, such as shales, maintain their pore pressure. This can make the drilling of certain depleted zones impossible because the mud weight required to support the shale exceeds the fracture pressure of the sands and silts.

Fluid losses are generally classified in four categories. Seepage losses are characterized by losses of from about 0.16 to about 1.6 m³/hr (about 1 to about 10 bbl/hr) of mud. They may be confused with cuttings removal at the surface. Seepage losses sometimes occur in the form of filtration to a highly permeable formation. A conventional LCM, particularly sized particles, is usually sufficient to cure this problem. If formation damage or stuck pipe is the primary concern, attempts are generally made to cure losses before proceeding with drilling. Losses greater than seepage losses, but less than about 32 m³/hr (about 200 bbl/hr), are defined as partial losses. In almost all circumstances when losses of this type are encountered, regaining full circulation is required. Sized solids alone may not cure the problem. When losses are between about 32-48 m³/hr (200-300 bbl/hr), they are called severe losses, and conventional LCM systems may not be sufficient. Severe losses particularly occur in the presence of wide fracture widths. As with partial losses, regaining full circulation is required. If conventional treatments are unsuccessful, spotting of LCM or viscous pills may cure the problem. The fourth category is total losses, when the fluid loss exceeds about 48 m³/hr (about 300 bbl/hr). Total losses may occur when fluids pumped past large caverns or vugs. In this case, the common solution is to employ cement plugs and/or polymer pills, to which LCM may be added for improved performance. An important factor, in practice, is the uncertainty of the distribution of zones of these types of losses, for example, a certain size fracture may result in severe loss or total loss depending on the number of such fractures downhole.

The use of fibers and solids to prevent lost circulation during drilling operations has been widely described. Such fibers include, for example, jute, flax, mohair, lechuguilla fibers, synthetic fibers, cotton, cotton linters, wool, wool shoddy, and sugar cane fibers. One known process for preventing or treating lost circulation involves the addition, at concentrations ranging between about 1.43 and about 17.1 kg/m³ of water-dispersible fibers having a length between about 10 and about 25 mm, for instance glass or polymer fibers, to a pumped aqueous base-fluid including solid particles having an equivalent diameter of less than about 300 microns. Another known process utilizes melt-processed inorganic fibers selected from basalt fibers, wollastonite fibers, and ceramic fibers. Such known methods and compositions, however, typically require large amounts of fibers.

### SUMMARY

The present disclosure reveals compositions and methods by which escape of wellbore fluids into subterranean formations may be minimized or prevented.

In an aspect, embodiments relate to compositions comprising stiff fibers, flexible fibers and solid plugging particles. The length of the stiff fibers is between 2 mm and 12 mm, and the diameter of the stiff fibers is between 20 μm and 60 μm. The length of the flexible fibers is between 2 mm and 12 mm, and the diameter of the flexible fibers is between 8 μm and 19 μm.

In a further aspect, embodiments relate to methods for blocking fluid flow through at least one pathway in a subterranean formation penetrated by a wellbore. Compositions, concentrations and dimensions are selected for rigid fibers, flexible fibers and solid plugging particles. A base fluid is prepared to which the fibers and particles are added, and the resulting blocking fluid is then forced into the pathway. The fibers form a mesh across the pathway, and the solid particles plug the mesh, thereby blocking fluid flow. The stiff fibers may have a diameter between 20 μm and 60 μm and a length between 2 mm and 12 mm, and the flexible fibers may have a diameter between 8 μm and 19 μM and a length between 2 mm and 12 mm.

In yet a further aspect, embodiments relate to methods for treating a geologic formation penetrated by a wellbore in a subterranean well. A treatment fluid is prepared that comprises a base fluid, stiff fibers, flexible fibers and solid plugging particles. The treatment fluid is injected into vugs, cracks, fissures or combinations thereof in the geologic formation. The fibers form a mesh across the pathway, and the solid particles plug the mesh, thereby blocking fluid flow. The stiff fibers may have a diameter between 20 μm and 60 μm and a length between 2 mm and 12 mm, and the flexible fibers may have a diameter between 8 μm and 19 μm and a length between 2 mm and 12 mm.

In yet a further aspect, embodiments relate to methods for stimulating a subterranean formation penetrated by a wellbore, the formation having at least two zones with different permeabilities. Compositions, concentrations and dimensions are selected for rigid fibers, flexible fibers and solid plugging particles. A base fluid is prepared to which the fibers and particles are added, and the resulting blocking fluid is then forced into the formation. Fluid flow into regions of higher permeability is blocked, and fluid flow into regions of lower permeability is permitted. The stiff fibers may have a diameter between 20 μm and 60 μm and a length between 2 mm and 12 mm, and the flexible fibers may have a diameter between 8 μm and 19 μm and a length between 2 mm and 12 mm.

### BRIEF DESCRIPTION OF THE DRAWINGS

FIG. 1 is a schematic diagram depicting fiber deflection arising from an applied force.

FIG. 2 shows a schematic diagram of the lost-circulation testing apparatus used in the foregoing examples.

FIG. 3 shows a magnified view of a cylinder in which a slot has been cut. The slot simulates an opening in the formation rock of a subterranean well.

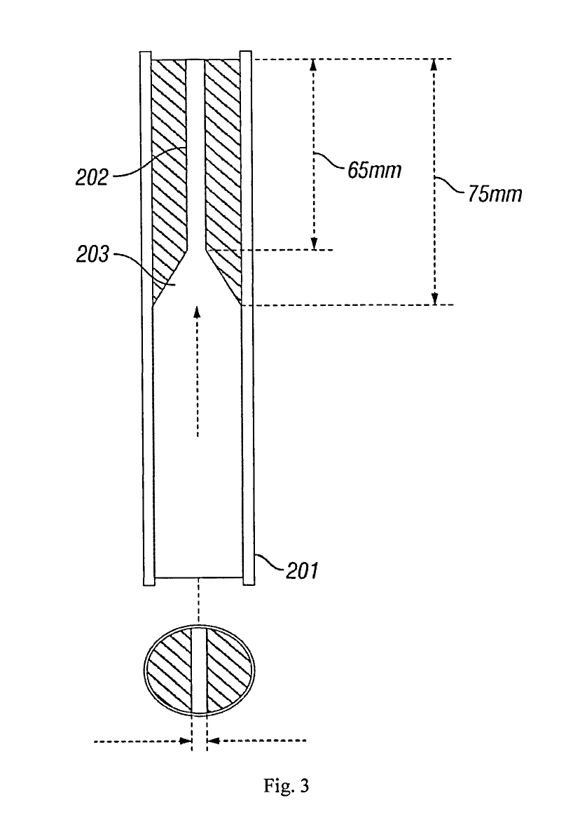

### DETAILED DESCRIPTION

Although the following discussion emphasizes blocking fractures encountered during drilling, the fibers and methods of the disclosure may also be used during cementing and other operations in which fluid loss or lost circulation are encountered. The disclosure will be described in terms of treatment of vertical wells, but is equally applicable to wells of any orientation. The disclosure will be described for hydrocarbon-production wells, but it is to be understood that the disclosed methods can be used for wells for the production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the Applicants appreciate and understand that any and all data points within the range are to be considered to have been specified, and that the Applicants have possession of the entire range and all points within the range.

Applicants have determined that, in the use of mixtures of fibers and solid particles to minimize or prevent fluid losses and lost circulation, an important factor in the selection and use of suitable fibers is that a combination of stiff fibers and flexible fibers of certain lengths and diameters provides superior performance in the context of blocking the escape of wellbore fluids into the formation rock. The fiber-particle mixtures may be suitable for use in drilling fluids, cement slurries, gravel packing fluids, acidizing fluids and hydraulic fracturing fluids. The drilling fluids may be water-base, oil-base, synthetic or emulsions. In the context of acidizing and hydraulic fracturing, the fiber-particle mixtures may be used to provide diversion—directing fluid flow from high-permeability regions into lower permeability regions.

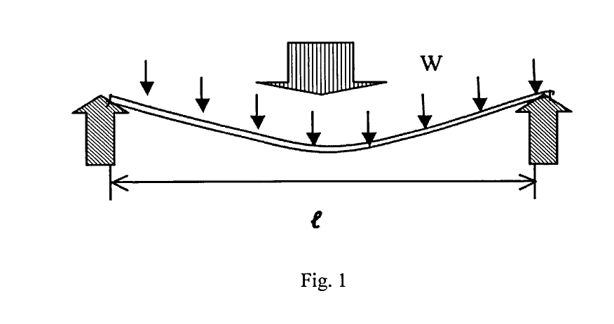

Stiffness is proportional to the Young's modulus of a fiber, and is generally known as the resistance to deformation. Fiber stiffness is one of the main characteristics affecting fiber performance. A simplified approach to characterize fiber resistance is to consider the fiber to be similar to structural beam, bending between two supports on each end. This is illustrated in FIG. 1, showing the deflection of a fiber of length l, deforming under an applied load W.

Several assumptions were used to obtain an estimate of the fiber deflection when exposed to a load. This was a simplified theoretical approach for estimating the strength of a fiber. The assumptions were as follows:
Calculations were based on ambient conditions in air.
The load was the pressure drop acting directly towards the fiber.
The load was uniform over the fiber length.
There was no fiber overlapping.
   The load was calculated from the applied pressure (for example 70 gram-force/square millimeter [100 psi]) and the fiber surface area exposed to that pressure.

Fiber Deflection:

$$y = \frac{5}{384} \frac{{WI}^{3}}{EI} \qquad ( 1 )$$

Cylindrical Inertia:

$$\begin{matrix}{I}_{c} = \frac{π {r}^{4}}{4} , or & ( 2 ) \\ {I}_{c} = 0.0491 {d}^{4} & ( 3 )\end{matrix}$$

Rectangular Inertia:

$${I}_{r} = \frac{{tb}^{3}}{12} \qquad ( 4 )$$

W=Weight or force causing the deflection (grams)

### E=Modulus of Elasticity (Kg/mm2)

I=Moment of Inertia (mm⁴)
l=Fracture width (mm)
y=Deflection (mm)
r=Fiber radius (micron)
t=Fiber thickness (mm)
b=Fiber width/breadth (mm)

From the preceding equations, one may derive an expression for calculating “stiffness.”

$$S = \frac{{Ed}^{4}}{{WI}^{3}} , where \qquad ( 5 )$$

S=stiffness.

These equations may be applied to fibers of regular or irregular cross-sectional shape. An example of stiffness calculations for fibers having circular cross sections is given below.

The deflection is proportional to 1/stiffness, and the W and I in Eq. 1 were kept constant for all the fibers and the stiffness was thus calculated. Table 1 presents “stiffness factors,” defined as the ratio of the stiffness of a given fiber to the stiffness of a glass fiber (GL) used in experiments that will be described later in the Examples section. The glass fibers had a Young's modulus of 65 GPa, a 20-micron diameter and were 12 mm long. The nature of the polypropylene (FM), nylon (NL) and crosslinked-polyvinyl alcohol (R1 and R2) fibers will also be described later in more detail. The calculation of the stiffness or stiffness factor for the rectangular fiber is the same as for the circular fibers, except that the inertia rectangle expression (Eq. 4) would be used.

TABLE 1
Stiffness Estimation

| | | Diameter/ | | |
|---|---|---|---|---|
| | | thickness | E | Stiffness |
| Fiber | Material | (μm) | (Kg/mm2) | factor |
| 1. GL - 20 microns | Alkaline | 20 | 6628.16 | 1.000 |
| | resisted glass | | | |
| 2. FM - 45 microns | Polypropylene | 45 | 152.96 | 0.591 |
| 3. NL - 150 microns | Nylon | 150 | 203.94 | 97.356 |
| 4. NL - 250 microns | Nylon | 250 | 203.91 | 751.202 |
| 5. NL - 280 microns | Nylon | 280 | 203.91 | 1182.031 |
| 6. FM - 12.5 microns | Polypropylene | 12.5 | 152.96 | 0.004 |
| 7. NL - 50 microns | Nylon | 50 | 203.94 | 1.202 |
| 8. R1 | Crosslinked | 80 | 2957.18 | 1014.818 |
| | Polyvinyl | | | |
| | alcohol | | | |
| 9. R2 | Crosslinked | 100 | 2549.29 | 240.385 |
| | Polyvinyl | | | |
| | alcohol | | | |

The stiff fibers of the disclosure may have a diameter between 20 μm and 60 μm, or between 30 μm and 50 μm. The length of the stiff fibers may be between 2 mm and 12 mm, 3 mm and 10 mm or 4 mm and 8 mm.

The flexible fibers of the disclosure may have a diameter between 8 μm and 19 μm, or between 10 μm and 14 μm. The length of the flexible fibers may be between 2 mm and 12 mm, 3 mm and 10 mm or 4 mm and 8 mm.

The fibers may comprise glass, ceramics, carbon (including carbon-based compounds), elements in metallic form, metal alloys. The fibers may also comprise degradable polymers, including polylactic acid (PLA), polyglycolic acid (PGA), polyethylene terephthalate (PET), polyester, polyamide, polycaprolactam and polylactone. Combinations of these fiber types are also envisioned.

In the case of PLA fibers, the Young's modulus varies from 0.35 GPa to 2.8 GPa. According to the calculations described earlier, the maximum stiffness factor for 40-μm diameter PLA fiber would be 0.69. According to the disclosure, such fibers would be considered as being “stiff.”

The degradable polymers may stay substantially intact in the wellbore while required for bridging or plugging during a wellbore operation. After the operation, fiber decomposition may take place via thermolysis or another chemical transformation such as hydrolysis. The decomposition products may be water- or oil-soluble, thereby minimizing damage to formations or production. For the purposes of this disclosure, a fiber may be considered to be decomposed if it disintegrates into a powder upon the application of pressure with a mechanical device such as a spatula.

Typical fiber decomposition data are presented in Table 2. The fibers were immersed in a water-in-oil emulsion drilling fluid (30% water). The Standard PLA was Trevira™ 260, available from Trevira GmbH, Bobingen, Germany. The High-Temp PLA was Biofront™, available from Teijin, Ltd., Japan. The Nylon-6 was obtained from Snovi Chemical (Shanghai) Co. Ltd., China.

TABLE 2
Fiber decomposition data.

| | Decomposition Times (days) | | | |
|---|---|---|---|---|
| Fiber | 80° C. | 100° C. | 120° C. | 150° C. |
| Standard PLA | 3 | 1 | — | — |
| High-Temp | 16 | 3 | — | — |
| PLA | | | | |
| Nylon-6 | — | — | 18 | 10 |

The weight ratio between the stiff and flexible fibers may be between 40% stiff/90% flexible w/w and 90% stiff/10% flexible w/w, or may be between 50% stiff/50% flexible w/w and 80% stiff/20% flexible w/w.

The solid plugging particles may be in granular or lamellar form or both. They may comprise carbonate minerals, mica, cellophane flakes, rubber, polyethylene, polypropylene, polystyrene, poly(styrene-butadiene), fly ash, silica, mica, alumina, glass, barite, ceramics, metals and metal oxides, starch and modified starch, hematite, ilmenite, ceramic microspheres, glass microspheres, magnesium oxide, graphite, gilsonite, cement, microcement, nut plugs or sand, and mixtures thereof. The particles may comprise carbonate minerals, and may comprise calcium carbonate.

For the particles, the size may be about 5-1000 μm, may be about 10-300 μM, and may be about 15-150 μm. The particle loading range may be the same as the fiber loading range. The particles may also be present in a multimodal particle size distribution, having coarse, medium and fine particles.

Coarse, medium and fine calcium-carbonate particles may have particle-size distributions centered around about 10 μm, 65 μm, 130 μm, 700 μm or 1000 μm, in a concentration range between about 5 weight percent to about 100 percent of the total particle blend. Mica flakes are particularly suitable components of the particle blend. The mica may be used in any one, any two, or all three of the coarse, medium, and fine size ranges described above, in a concentration range between about 2 weight percent to about 10 weight percent of the total particle blend. Nut plug may be used in the medium or fine size ranges, at a concentration between about 2 weight percent to about 40 weight percent. Graphite or gilsonite may be used at concentrations ranging from about 2 weight percent to about 40 weight percent. Lightweight materials such as polypropylene or hollow or porous ceramic beads may be used within a concentration range between about 2 weight percent to about 50 weight percent. The size of sand particles may vary between about 50 microns to about 1000 microns. If the particles are included in a cement slurry, the slurry density may be between about 1.0 kg/L to about 2.2 kg/L (about 8.5 lbm/gal to about 18 lbm/gal).

In an aspect, embodiments relate to compositions comprising stiff fibers, flexible fibers and solid plugging particles. The length of the stiff fibers may be between 2 mm and 12 mm, and the diameter of the stiff fibers may be between 20 μm and 60 μm. The length of the flexible fibers may be between 2 mm and 12 mm, and the diameter of the flexible fibers may be between 8 μm and 19 μm.

In a further aspect, embodiments relate to methods for blocking fluid flow through at least one pathway in a subterranean formation penetrated by a wellbore. Compositions, concentrations and dimensions are selected for rigid fibers, flexible fibers and solid plugging particles. A base fluid is prepared to which the fibers and particles are added, and the resulting blocking fluid is then forced into the pathway. The fibers form a mesh across the pathway, and the solid particles plug the mesh, thereby blocking fluid flow.

In yet a further aspect, embodiments relate to methods for treating a geologic formation penetrated by a wellbore in a subterranean well. A treatment fluid is prepared that comprises a base fluid, stiff fibers, flexible fibers and solid plugging particles. The treatment fluid is injected into vugs, cracks, fissures or combinations thereof in the geologic formation. The fibers form a mesh across the pathway, and the solid particles plug the mesh, thereby blocking fluid flow.

In yet a further aspect, embodiments relate to methods for stimulating a subterranean formation penetrated by a wellbore, the formation having at least two zones with different permeabilities. Compositions, concentrations and dimensions are selected for rigid fibers, flexible fibers and solid plugging particles. A base fluid is prepared to which the fibers and particles are added, and the resulting blocking fluid is then forced into the formation. Fluid flow into regions of higher permeability is blocked, and fluid flow into regions of lower permeability is permitted.

For all aspects, the stiff fibers may have a diameter between 20 μm and 60 μm, a length between 2 mm and 12 mm, and may be present at concentrations between 3.4 kg/m³ and 12.5 kg/m³. The flexible fibers may have a diameter between 8 μm and 19 μm, a length between 2 mm and 12 mm and may be present at concentrations between 5.1 kg/m³ and 18.8 kg/m³. The weight ratio between the stiff and flexible fibers may be between 40%/60% w/w and 90%/10% w/w.

Accordingly, the total fiber concentration in the compositions may vary from about 8.5 kg/m³ to about 31.3 kg/m³.

For all aspects, the fibers may comprise glass, ceramics, carbon, elements in metallic form, metallic alloys, polylactic acid, polyglycolic acid, polyethylene terephthalate, polyols, polyamides, polyesters, polycaprolactams or polylactones or combinations thereof. The solid particles may comprise granular particles or lamellar particles or combinations thereof.

### EXAMPLES

The present disclosure may be further understood from the following examples.

Fluid blocking tests were performed in the laboratory with the following materials. The base fluid was VERSACLEAN™ drilling fluid, a water-in-oil emulsion system available from MI-S WACO, Houston, Tex., USA. The oil phase is mineral oil.

The rigid fibers were based on polylactic acid (PLA), 4 mm long and 40 μm in diameter. The flexible fibers were also PLA based, 6 mm long and 12 μm in diameter.

### Example 1

Flow tests were performed with a bridge testing device. The device comprised a metal tube filled with the formulation to be tested, pushed through a slot of varying diameter with an HPLC pump pumping water. The maximum flow rate was 1 L/min. Pressure was monitored with a pressure transducer (available from Viatran, Inc.), and the device could be operated at a maximum pressure of 500 psi (34.5 bar). The apparatus was constructed by the Applicants, and was designed to simulate fluid flow into a formation-rock void. A schematic diagram is shown in FIG. 1.

A pump 101 was connected to a tube 102. The internal tube volume was 500 mL. A piston 103 was fitted inside the tube. A pressure sensor 104 was fitted at the end of the tube between the piston and the end of the tube that was connected to the pump. A slot assembly 105 was attached to the other end of the tube.

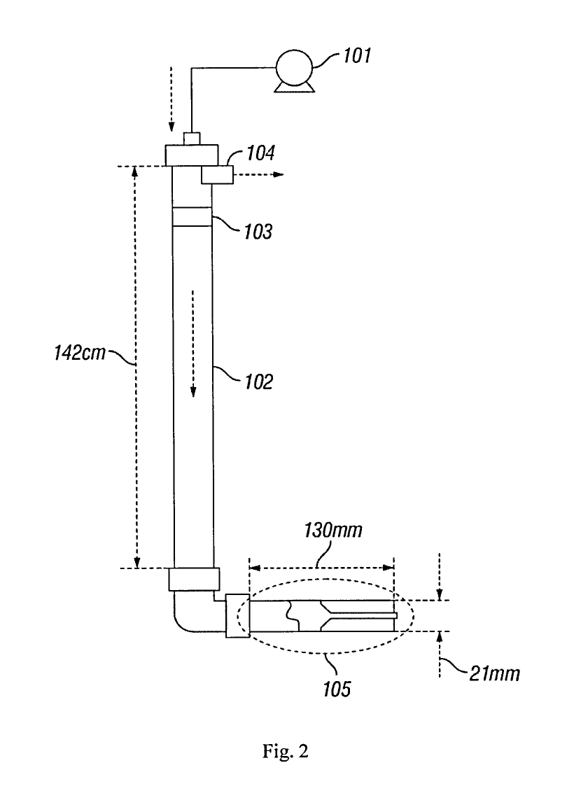

A detailed view of the slot assembly is shown in FIG. 2. The outer part of the assembly was a tube 201 whose dimensions are 130 mm long and 21 mm in diameter. The slot 202 was 65 mm long. Various slots were available with widths varying between 1 mm and 5 mm. Preceding the slot was a 10-mm long tapered section 203. Slots lined with sandpaper were also used to simulate the rough surface of a rock fracture. The sandpaper had a 250-300 μm grain size.

During the experiments, the tested slurries were pumped through the slot. If plugging took place, a rapid pressure rise was observed. The test terminated when the pressure reached the 34.5-bar (500-psi) limit.

Two fluids were prepared. The first contained 114 kg/m³ (40 lbm/bbl) of a commercial fibrous lost-circulation additive, FORM-A-BLOK™ available from M-I SWACO, Houston, Tex. The additive was slurried in mineral oil with barite at a concentration of 28.4 kg/m³ (10 lbm/bbl).

The second was a blend of rigid and flexible fibers in an 80 wt % rigid/20 wt % flexible ratio. The water-to-oil ratio of the drilling fluid was 70:30, the fluid density was 1200 kg/m³ (10 lbm/gal) and the viscosity was 35 cP. Barite was used as the weighting material. The total fiber concentration in the fluid was 22.8 kg/m³ (8 lbm/bbl). For both fluids, calcium carbonate particles with d₅₀=180 μm were present at a concentration of 45.6 kg/m³ (16 lbm/bbl).

Both fluids underwent testing in the bridge testing device as described earlier. The slot size was 5 mm. The fluid containing FORM-A-BLOK™, despite the higher concentration in the fluid, was unable to plug the slot. However, the fluid containing the fiber blend of the disclosure successfully plugged the slot.

### Example 2

The test apparatus described in Example I was used. The water-to-oil ratio of the drilling fluid was 70:30, the viscosity was 18 cP and the concentration of calcium carbonate particles (d₅₀=180 μm) in the fluid was 45.6 kg/m³ (16 lbm/bbl). The fluid density was 1020 kg/m³ (8.5 lbm/gal). Barite was used as the weighting material. The total fiber concentration was held constant at 17.1 kg/m³ (6 lbm/bbl); however, various weight ratios of rigid and flexible fibers were tested. The 2 mm and 3 mm slots were used. The results are presented in Table 1. After the pump stopped when the 34.5-bar pressure limit was reached, the pressure decay in the system was observed. If the pressure dropped to zero very quickly, a bridge was formed. The bridge was permeable and allowed some fluid to pass through the filter cake. If the pressure decay was very slow, a plug was said to have formed. This indicated a much less permeable filter cake. “No bridge” means that the system pressure did not attain 34.5 bar (500 psi).

TABLE 1
Results of fiber-solids plugging experiments.

| | | | | | |
|---|---|---|---|---|---|
| Slot Width | 2 and 3 | 3 | 3 | 3 | 3 |
| (mm) | | | | | |
| Rigid | 100/0 | 70/30 | 50/50 | 20/80 | 0/100 |
| Fiber/Flexible | | | | | |
| Fiber Ratio | | | | | |
| Result | bridge | plug | plug | no | no |
| | | formed | formed | bridge | bridge |

### Example 3

The test apparatus described in Example 1 was used. The water-to-oil ratio of the drilling fluid was 70:30, the viscosity was 34 cP and the concentration of calcium carbonate particles (d₅₀=180 μm) in the fluid was such that the fiber:carbonate weight ratio was 3:8. The fluid density was 1230 kg/m³ (10 lbm/gal). Barite was used as the weighting material. The stiff/flexible fiber ratio was held constant at 40/60, and the total fiber concentration was varied from 5.7 kg/m³ to 11.4 kg/m³ (2 lbm/bbl to 4 lbm/bbl). A 5-mm sandpaper slot was used, and the HPLC pump was operated at 750 ml/min. At a total fiber concentration of 5.7 kg/m³, no bridge was formed in the slot. At a total fiber concentration of 8.6 kg/m³, a bridge was formed in the slot. At a total fiber concentration of 11.4 kg/m³, a plug was formed in the slot.

Although various embodiments have been described with respect to enabling disclosures, it is to be understood that this document is not limited to the disclosed embodiments. Variations and modifications that would occur to one of skill in the art upon reading the specification are also within the scope of the disclosure, which is defined in the appended claims.

1. A composition, comprising: stiff fibers, flexible fibers and solid plugging particles, wherein the length of the stiff fibers is between 2 mm and 12 mm, the diameter of the stiff fibers is between 20 μm and 60 μm, the length of the flexible fibers is between 2 mm and 12 mm and the diameter of the flexible fibers is between 8 μm and 19 μm.

2. The composition of claim 1, wherein the stiff fibers are present at concentrations between 3.4 kg/m³ and 12.5 kg/m³, and the flexible fibers are present at concentrations between 5.1 kg/m³ and 18.8 kg/m³.

3. The composition of claim 1, wherein the weight ratio between the stiff and flexible fibers is between 40%/60% w/w and 90%/10% w/w.

4. The composition of claim 1, wherein the fibers comprise glass, ceramics, carbon, elements in metallic form, metallic alloys, polylactic acid, polyglycolic acid, polyethylene terephthalate, polyols, polyamides, polyesters, polycaprolactams or polylactones or combinations thereof.

5. The composition of claim 1, wherein the solid plugging particles comprise granular particles or lamellar particles or combinations thereof, and the size of the particles is between 5 μm and 1000 μm.

6. The composition of claim 1, wherein the solid plugging particles comprise calcium carbonate particles.

7. A method for blocking fluid flow through at least one pathway in a subterranean formation penetrated by a wellbore, comprising:
(i) selecting compositions, concentrations and dimensions of stiff fibers, flexible fibers and solid plugging particles;
(ii) preparing a base fluid to which the fibers and particles are added; and
(iii) forcing the blocking fluid into the pathway;
wherein, the fibers form a mesh across the pathway, and the solid particles plug the mesh, thereby blocking fluid flow,
wherein, the stiff fibers have a diameter between 20 μm and 60 μm and a length between 2 mm and 12 mm,
wherein, the flexible fibers have a diameter between 8 μm and 19 μm and a length between 2 mm and 12 mm.

8. The method of claim 7, wherein the stiff fibers are present at concentrations between 3.4 kg/m³ and 12.5 kg/m³, and the flexible fibers are present at concentrations between 5.1 kg/m³ and 18.8 kg/m³.

9. The method of claim 7, wherein the weight ratio between the stiff and flexible fibers is between 40%/60% w/w and 90%/10% w/w.

10. The method of claim 7, wherein the size of the particles is between 5 μm and 1000 μm.

11. The method of claim 7, wherein the fibers comprise glass, ceramics, carbon, elements in metallic form, metallic alloys, polylactic acid, polyglycolic acid, polyethylene terephthalate, polyols, polyamides, polyesters, polycaprolactams or polylactones or combinations thereof.

12. The method of claim 7, wherein the solid plugging particles comprise granular particles or lamellar particles or combinations thereof.

13. The method of claim 7, wherein the base fluid is a drilling fluid, a cement slurry, an acidizing fluid, a hydraulic fracturing fluid or a gravel packing fluid.

14. A method for stimulating a subterranean formation penetrated by a wellbore, the formation having at least two zones with different permeabilities, comprising:
(i) selecting compositions, concentrations and dimensions of stiff fibers, flexible fibers and solid plugging particles;
(ii) preparing a base fluid to which the fibers and particles are added; and
(iii) forcing the fluid into the subterranean formation;
wherein fluid flow into regions of higher permeability is blocked, and fluid flow into regions of lower permeability is permitted
wherein, the fibers form a mesh across the pathway, and the solid particles plug the mesh, thereby blocking fluid flow,
wherein, the stiff fibers have a diameter between 20 μm and 60 μm and a length between 2 mm and 12 mm,
wherein, the flexible fibers have a diameter between 8 μm and 19 μm and a length between 2 mm and 12 mm.

15. The method of claim 14, wherein the stiff fibers are present at concentrations between 3.4 kg/m³ and 12.5 kg/m³, and the flexible fibers are present at concentrations between 5.1 kg/m³ and 18.8 kg/m³.

16. The method of claim 14, wherein the weight ratio between the stiff and flexible fibers is between 40%/60% w/w and 90%/10% w/w.

17. The method of claim 14, wherein the solid plugging particles comprise granular particles or lamellar particles or combinations thereof.

18. The method of claim 14, wherein the size of the particles is between 5 μm and 1000 μm.

19. The method of claim 14, wherein the base fluid is an acidizing fluid, a hydraulic fracturing fluid or both.

20. The method of claim 14, wherein the fibers comprise glass, ceramics, carbon, elements in metallic form, metallic alloys, polylactic acid, polyglycolic acid, polyethylene terephthalate, polyols, polyamides, polyesters, polycaprolactams or polylactones or combinations thereof.
